(19) United States
(12) Patent Application Publication
(10) Pub. No.: US 2023/0059130 A1
(43) Pub. Date: Feb. 23, 2023

(54) METHOD AND DEVICE FOR GENERATING RANDOM NUMBERS

(71) Applicant: TAAL DIT GmbH, Zug (CH)

(72) Inventor: Jerry David CHAN, Vancouver (CA)

(21) Appl. No.: 17/915,026

(22) PCT Filed: Feb. 26, 2021
(86) PCT No.: PCT/EP2021/054812

§ 371 Date: Sep. 27, 2022

(30) Foreign Application Priority Data
Mar. 31, 2020 (GB) 2004684.3

(51) Int. Cl. G06F 7/58

(52) U.S. Cl. CPC G06F 7/588; H04L 9/3239

(57) ABSTRACT

A computer-implemented method of generating random numbers based on blockchain transactions, wherein the method is performed by a generating party and comprises: obtaining a candidate block header, wherein the candidate block header is based on a set of blockchain transactions; applying a hash function to at least the candidate block header one or more times, wherein each application of the hash function to at least the candidate block header generates a respective hash digest; generating one or more random numbers, wherein each random number is generated based on a respective hash digest; and outputting the one or more random numbers to one or more consuming devices.

### TECHNICAL FIELD

The present disclosure relates to a method and apparatus for generating random numbers, e.g. for outputting to an application ran on a computing device.

### BACKGROUND

The generation of random numbers is important for a wide variety of applications, e.g. computer simulation, financial back testing, financial risk management, financial derivatives pricing, artificial intelligence, machine learning, particle physics simulations, weather predicting, protein folding, probabilistic computing, online gaming, online gambling, etc.

Random numbers are typically produced by general devices called random number generators (RNGs). RNGs come in two sorts, pseudorandom number generators (PRNGs) and true random number generators (TRNGs). Pseudorandom numbers are so-called because they are not truly random. That is, pseudorandom numbers (PRNs) are actually completely deterministic. A sequence of PRNs only appears to be a sequence of random numbers because a human cannot readily see the pattern between successive numbers in the sequence.

On the other hand, a sequence of truly random numbers (TRNs) are truly random in that there is no deterministic way to generate the next number given the previous number(s) in the sequence. TRNs are typically obtained by sampling from the physical universe through observation. For instance, a TRNG can generates random numbers by sampling from a statistically random signal, such as thermal noise.

Computers work algorithmically, and are therefore excellent PRNGs. TRNGs however, are usually a piece of specialist hardware, which must sample or observe true randomness from the physical environment in order to produce truly random numbers.

### SUMMARY

Truly random numbers, by their very nature, are more desirable than pseudorandom numbers since PRNs are not really random—they only give the appearance of randomness. However, TRNs are more computationally expensive and slower to generate than PRNs, which are typically are fast and computationally inexpensive to generate. Some hardware TRNGs use a physical entropy sourcing device, such as a thermocouple or a device which uses quantum tunnelling effect in order to record true randomness. These devices are typically complex and expensive, both computationally and financially.

On the other hand, some computers use a hybrid method to produce random numbers, which is a compromise making use of both TRNs and PRNs. A source of entropy is used by a TRNG to produce a slow stream of TRNs which are subsequently used to ‘seed’ a PRNG, which then produces pseudorandom numbers in a sufficient quantity and at a sufficient rate for the application requiring random numbers. In order to generate random numbers statistically close enough to TRNs, a device with a human input device (e.g. a keyboard or mouse) can collect entropy so that it can be used to seed a PRNG.

Mass generation of random numbers requires a fixed steady flow of TRNs in order to be used as seeds for the PRNGs.

Conventional TRNGs are generally rather inefficient compared to PRNGs, taking considerably longer time to produce random numbers. They are also nondeterministic, meaning that a given sequence of numbers cannot be reproduced, although the same sequence may of course occur several times by chance. TRNGs have no period.

It would therefore be desirable to produce truly random numbers at a rate and computational complexity akin to producing pseudorandom numbers.

According to one aspect disclosed herein, there is provided a computer-implemented method of generating random numbers based on blockchain transactions, wherein the method is performed by a generating party and comprises: obtaining a candidate block header, wherein the candidate block header is based on a set of blockchain transactions; applying a hash function to at least the candidate block header one or more times, wherein each application of the hash function to at least the candidate block header generates a respective hash digest; generating one or more random numbers, wherein each random number is generated based on a respective hash digest; and outputting the one or more random numbers to one or more consuming devices.

The present invention utilizes transactions, produced by a distributed peer-to-peer network as the entropy source for seeding a random number generator. With millions of client applications sending messages (i.e. transactions) in a small world gossip network, the content and arrival sequence of the messages can be considered to be truly random. The content is random in the sense that (within the rules of the blockchain network) any content can be included in a transaction. The arrival sequence is random in the sense that transactions can be submitted to the blockchain network at any time. In other words, it is not plausibly possible to calculate what transactions will be submitted to the blockchain network, in totality, at any given point in time. Doing so would be akin to trying to predict the movement of molecules in a gas—it is chaotic.

The blockchain transactions present a perfect source of environmental entropy which can be used to generate truly random numbers, which in turn can be used to mass produce random numbers. In the present invention, hashing algorithms, which are also used as part of the blockchain network's proof-of-work mechanism, are used to produce random numbers from the initial seed (the candidate block header). Hash functions are one-way functions, such that given a pre-image, it is fast and simple to algorithmically generate a large number of hash digests of a message, but it is mathematically infeasible to do the reverse operation. Since a hash function is algorithmic, it is deterministic, and therefore the hash function serves to ‘multiply’ the throughput of the original entropy source, which are the transactions broadcast to the network. As a one-bit change in the pre-image will result in a wildly different output, randomness is preserved. Therefore the present invention enables a high rate of random numbers (e.g. the hash digests) to be produced from a randomly sampled seed.

The present invention generates random numbers from a hash digest based on the (real-time) transaction load of the blockchain, and thus there is no period or predictability of the random numbers. Therefore the generated random numbers are TRNs.

According to another aspect disclosed herein, there is provided an apparatus configured to generate random numbers based on blockchain transactions, wherein the apparatus comprises: an input interface configured to obtain a candidate block header, wherein the candidate block header is based on a set of blockchain transactions; a hashing component configured to apply a hash function to at least the candidate block header one or more times, wherein each application of the hash function to at least the candidate block header generates a respective hash digest; and an output interface configured to output one or more random numbers to one or more consuming devices, and wherein the apparatus is configured to generate the one or more random numbers, wherein each random number is generated based on a respective hash digest.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 schematically illustrates an example method for mining a new block to a blockchain;

FIG. 2 is a schematic block diagram of an example apparatus for generating random numbers; and

FIG. 3 schematically illustrates an example method for generating random numbers.

### DETAILED DESCRIPTION OF EMBODIMENTS

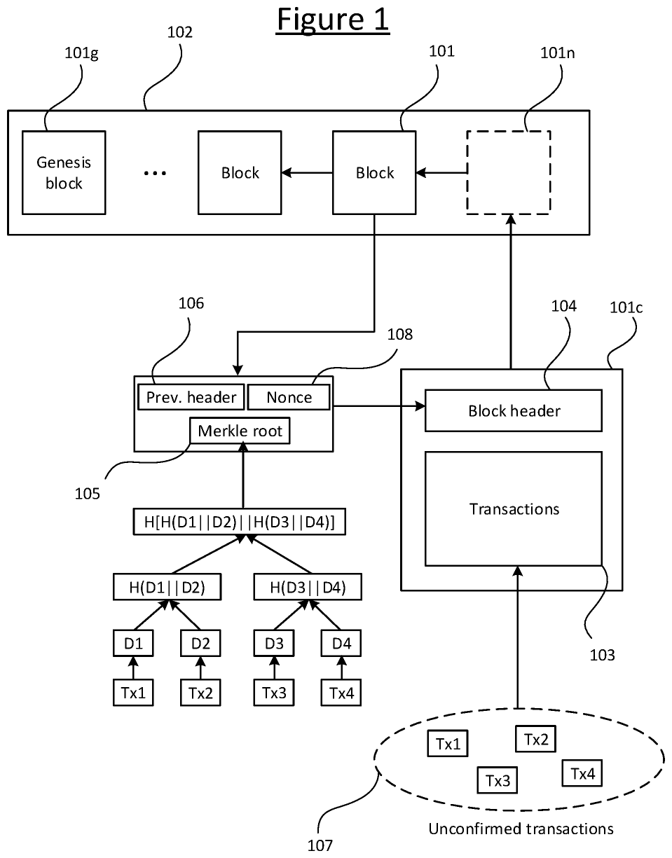

FIG. 1 schematically illustrates an example method for mining a new block 101n on a blockchain 102. A blockchain 102 is a form of distributed database (or ledger) that acts as a record of all valid transactions 103 that have ever been transmitted to the blockchain network.

Valid transactions 103 that are broadcast on the blockchain network are recorded on the blockchain 102 by miners (also referred to as mining nodes) in blocks. A blockchain transaction 103 is used to transfer custody of an amount of a digital token. Each transaction 103 includes, amongst other things, at least one input and at least one output. An input is a reference to an unspent transaction output (UTXO) from a previous transaction. A transaction 103 uses unspent transaction outputs (UTXOs) as inputs and distributes their value to new outputs. An output typically includes a locking condition that locks the value of that output, requiring certain data (e.g. a set of keys or other information) to be provided in an input of a new transaction 103 in order to be unlocked. Outputs can also be used to inscribe data onto the ledger. An input of a transaction 103 usually includes a digital signature that signs over a transaction 103. A chain of transactions 103 therefore includes a chain of digital signatures that maps out the entire history of valid exchanges of the digital tokens all the way back to their creation.

The blockchain 102 begins with a “genesis block” 101g, which is the first block 101 ever created. Each block on the blockchain 102 references a previous block, all the way back to the genesis block. That is, the n^{th} block 101 reference the n−1^{th} block 101, the n−1^{th} block reference the n−2^{th} block 101, and so on, back to the genesis block 101g.

A block 101 contains an ordered list of blockchain transactions 103 and a block header 104. The block header 104 includes a Merkle root 105 that is generated by hashing the ordered list of blockchain transactions 103 into a Merkle tree, a timestamp, a reference 106 to the previous block 101 that the present block 101 builds upon and the means to validate the “proof-of-work” needed for other miners to accept the block 101 as valid. That validation means is an answer to a hash puzzle which is unique to each block 101. The blockchain protocol run by nodes of the blockchain network uses a hashing algorithm that requires miners to pre-build their candidate block 101c before trying to solve the puzzle. New blocks 101n cannot be submitted to the network without the correct answer—the process of “mining” is essentially the process of competing to be the next to find the answer that “solves” the current block 101. The hash puzzle in each block 101 is difficult to solve, but once a valid solution is found, it is very easy for the rest of the network to confirm that the solution is correct. There are multiple valid solutions for any given block 101—only one of the solutions needs to be found for the block 101 to be solved.

The following briefly describes the process of attempting to mine a new block 101n to the blockchain 102. When a blockchain transaction 103 is transmitted to a mining node, it is first validated according to the consensus rules of the blockchain network. If the transaction 103 is valid it is added to a pool 107 of unconfirmed transactions 103. The pool 107 is sometimes referred to as a “mempool”. The mempool 107 acts as a temporary store of transactions 103 to be mined into the next block 101n. Each mining node will have its own mempool 107, and any given transaction 103 may be included in more than one mempool 107 if it has been broadcasted to more than one mining node.

A miner takes the transactions 103 it intends to include in the next block 101 and hashes them into a Merkle tree structure and includes the resulting Merkle root 105 within a candidate block header 104. The miner then hashes this candidate block header 104, attempting to find a valid proof-of-work. A Merkle tree is a data structure in the form of a tree of hash values. In the context of the blockchain 102, a transaction 103 is hashed to form a leaf node of the tree. Pairs of leaf nodes are concatenated and then hashed to form a node in a higher layer of the tree. Pairs of nodes in that layer are then concatenated and hashed to form a node in a yet higher layer of the tree. The process is repeated until only a single node is left, referred to as the root node, or the Merkle root 105.

A hash function is a function that converts a string of data of arbitrary length into a fixed length value, called the hash value or a hash digest. Hashing is a one-way function, meaning it is infeasible to determine what the input data is by looking at the hash value produced from it. On the other hand, it is trivial to run the same input data through the same hash function and reproduce the same hash. Some blockchain protocols use the SHA-256 hashing algorithm, and some protocols use the SHA-256 hashing algorithm twice, i.e. the candidate block header is passed through the same hashing algorithm twice.

A valid proof-of-work if found by hashing the candidate block header 104 (in combination with other data, as discussed below) until the result is less than another value, called the target value. The target value is automatically adjusted by the blockchain protocol so that, on average, it takes the blockchain network ten minutes to find a valid proof-of-work.

In order to change the hash value, a mining node must add additional information to the candidate block header 104. Mining nodes typically use two “nonce fields” to alter the value to be hashed, and thus alter the resulting hash value. A first nonce field 108 is included in the block header itself, and the second nonce field is included in a “coinbase transaction”. A coinbase transaction is a transaction created and included in the candidate block by the mining node. Each field includes a counter parameter that can be incremented. The hash function cycles through all values of the first nonce 108 field then increments (or otherwise changes) the second nonce field, before going through all permutations of the first nonce field 108 again. Incrementing the second nonce field involves recomputing the Merkle root 105 as it modifies the hash of the coinbase transaction, which is included in the Merkle tree.

When a mining node finds a valid proof-of-work hash for a block 101 (i.e. a candidate block header 104 that hashes to a value less than the target value), it broadcasts the new block 101n to the rest of the blockchain network. The other nodes on the network accept this new block 101n only if all the transactions 103 in it are valid and have not yet been included in a block. Every block 101 is timestamped and references the hash of the block 101 preceding it, thus resulting in a chain of blocks (i.e. the blockchain 102).

The above has been described in terms of an “output-based” transaction model. An alternative type of transaction model is an “account-based” model. In this model, each transaction 103 does not define the amount of the digital token to be transferred by referring back to an unspent transaction output, but instead rather by reference to an absolute account balance. The current state of all accounts is stored by the miners separate to the blockchain 102 and is updated constantly. In such a system, transactions 103 are ordered using a running transaction tally of the account (also called the “position”). This value is signed by the sender as part of their cryptographic signature and is hashed as part of the transaction reference calculation.

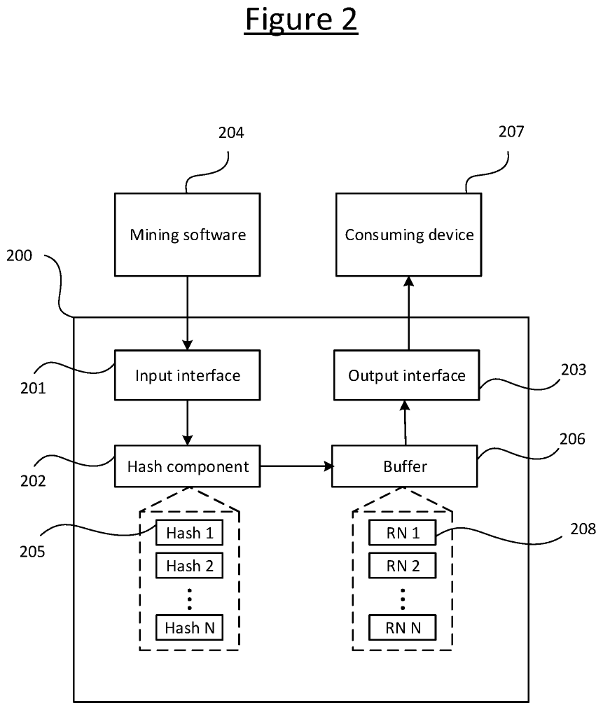

FIG. 2 schematically illustrates an apparatus according to embodiments of the present invention. The apparatus 200 comprises an input interface 201, a hashing component 202, and an output interface 203.

The input interface 201 is configured to obtain a candidate block header. Candidate block headers 104 have been discussed with reference to FIG. 1. A candidate block header 104 comprises a representation of a set of blockchain transactions, e.g. a Merkle root 105. The candidate block header 104 may also comprise a reference 106 to a previous block, a timestamp, and/or a nonce value 108. In some examples, the input interface 201 may obtain a set of transactions 103. In those examples, the input interface 201 is configured to obtain the candidate block header 104 by generating the candidate block header 104 based on the set of transactions 103. That is, the input interface 201 may comprise a component for constructing a Merkle tree to generate a Merkle root 105 of the set of transactions 103. The input interface 201 may be configured to obtain any other information required to construct the candidate block header 104. For instance, the input interface 201 may be configured to receive a reference to a previous block 101 of the blockchain 102, i.e. the block header of the previous block 101. The input interface 201 may be configured to obtain a candidate block template 101c comprising the candidate block header 104 and the set of transactions 103. Note that any instance of “obtaining” a data item (e.g. the candidate block header 104 or candidate block template 101c) may be taken to mean receiving that data item, unless the context requires otherwise.

In some examples, the input interface 201 may be connected to mining software 204. For instance, the mining software 204 may be configured to supply the apparatus 200, e.g. via the input interface 201, with the set of transactions 103 and/or the candidate block header 104. The mining software 204 may be configured to supply the apparatus 200 with additional information, e.g. the reference 106 to the previous block 101 of the blockchain 102. The mining software 204 may comprise, or otherwise have access to, a pool 107 of unconfirmed transactions from which the set of transactions 103 are supplied to the apparatus 200.

The hashing component 202 is configured to apply a hash function to at least the candidate block header 104. In some examples, the hashing component 202 is configured to apply the hash function to the candidate block template 101c, which comprises the candidate block header 104. The hashing component 202 is configured to generate one or more hash digests (or hash values) based on the input received from the input interface 201, e.g. the candidate block header 104. The hashing component 202 may generate a plurality of hash digests. For instance, the hashing component 202 may comprise a single hash function that hashes the candidate block 104 header multiple times. Additionally or alternatively, the hashing component 202 may comprise multiple hash functions 205, each configured to hash the candidate block header 104 one or more times. Each hash function 205 may apply the same hash function (e.g. SHA-256). Alternatively, one or more hash functions 205 may apply a different hash function (e.g. SHA-512). Applying a hash function 205 may comprise applying a sequence of hash functions (e.g. applying SHA-256 twice) to generate a single hash digest. Note that refence to hashing the candidate block header 104 should be taken to mean hashing at least the candidate block header 104, unless the context requires otherwise.

The hashing component 202 may be configured to supply the hash digests to the output interface 203. Alternatively, the hashing component 202 may be configured to supply the hash digests to a buffer 206, as discussed below.

The output interface 203 is configured to obtain one or more random numbers. The random numbers may be the hash digests themselves. Alternatively, the hash digests may be processed by the apparatus 200 to generate the random numbers. Processing of the hash digests will be discussed below. The output interface 203 is configured to output (i.e. supply) the random numbers to a consuming device 207. The output interface has a connection to the consuming device. That is, the output interface 203 has a connection to a communication channel between the apparatus 200 and the consuming device 207. In some embodiments, the apparatus 200 comprises the consuming device 207. Alternatively, the consuming device 207 may be separate from the apparatus 200. The communication channel may be a wired communication channel or a wireless communication channel. For instance, the output interface 203 may be connected to the consuming device 207 via the internet, or any other form of network, e.g. other forms of packet-switched networks.

The apparatus 200, or more specifically the output interface 203, may have a local area network (LAN) connection for LAN access, where random numbers are output to be consumed locally on a machine 207 in the local area network where the apparatus 200 is located. Additionally or alternatively, the output interface 203 may have a wide area network (WAN) connection for WAN access, where the RNs are transported over the WAN (e.g. internet) to the consuming device 207 from the network where the apparatus 200 is located.

In some examples, the apparatus 200 may output the random numbers to a plurality of consuming devices 207, one or more of which may be local devices, and one or more of which may be remote devices.

As shown in FIG. 2, the apparatus 200 may comprise a buffer 206. The buffer 206 is configured to store the generated random numbers (either in the form or hash digests, or after the hash digests have been processed). Therefore the buffer 206 may be configured to receive hash digests directly from the hashing component 202, or from a processing component connected between the hashing component 202 and the buffer 206. The buffer 206 may comprise a plurality of slots 208, each configured to store one or more random numbers. The buffer 206 may be configured to store a predefined number of random numbers. The buffer 206 may be a circular buffer. In some examples, the buffer 206 may operate a first in first out policy for storing the random numbers. That is, when new random numbers are output to the buffer 206, the buffer 206 may delete the “oldest” random numbers, i.e. the random number that have been stored in the buffer 206 for the longest period of time.

The buffer 205 may be connected to the output interface 203. In examples where the buffer 206 stores random numbers, the buffer 206 may be configured to output the random numbers to the output interface 203. In examples where the buffer 206 stores hash digests, the buffer 206 may be configured to output hash digests to the output interface 203. Alternatively, the buffer 206 may be configured to output the hash digests to a processing component for processing the hash digests into the random numbers.

The hash digests themselves may be the random numbers that are output to the consuming device 207. Alternatively, the apparatus 200 may comprise a processing component configured to generate random numbers based on the hash digests. For instance, hash digests may require processing to reduce the size of the random number (recall that the hash digest may be, for example, 256 bits in length). One operation that the processing component may perform is to remove some or all of the zeros present in the hash digest. For example, the leading zeros of the hash digest may be removed. Another operation that may be performed is to convert the hash digest to a number between zero and one, e.g. by using the hash digest as the decimal component of a number between zero and one. Another operation that may be performed is to select a subset of the hash digest as the random number. For instance, the first n bits of the hash digest may form the random number. One, some or all of the above operations may be performed by the processing component to generate a random number to be output to the consuming device 207.

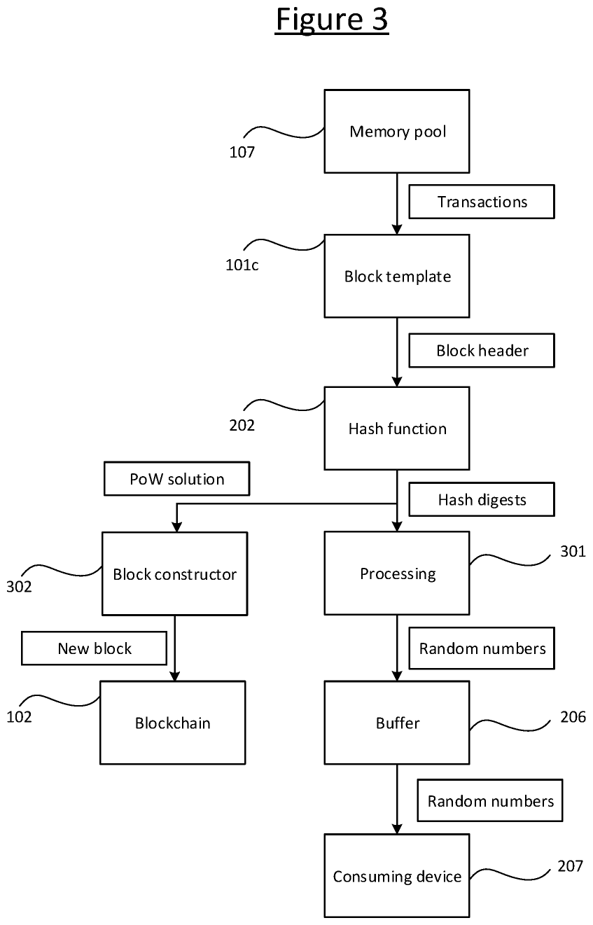

FIG. 3 schematically illustrates an example method performed by a generating party for generating random numbers in accordance with embodiments of the present invention. It will be appreciated that some features of the method are preferred optional features.

A block header 104 is obtained by the generating party. For example, a set of transactions 103 may be obtained from a memory pool (mempool) of unconfirmed transactions 103 that are yet to be mined into a block 101 on the blockchain 102. The set of transactions 103 and/or the candidate block header 104 may be supplied to the generating party from mining software 204 operating by a mining node. In some examples, the generating party may also operate the mining software 204 and thus have access to the set of transactions 103 and/or the block header 104. In some examples, the generating party may obtain a candidate block template 101c, e.g. by generating the candidate block template 101c from the set of transactions 103, or by being supplied with the candidate block template 101c from by the mining software.

The generating party, having obtained the candidate block header 104, supplies the candidate block header 104 to a hash function 202. The hash function 202 itself may comprises a plurality of hashing algorithms 205, which may or may not be the same hashing algorithm. For example, the hash function 202 may comprise one or more of the following hashing algorithms: SHA-256, SHA-512, RIPEMD-160, BLAKE2, BLAKE3, etc.

The hash function 202 may comprise a single hashing algorithm 205 that is configured to repeatedly hash the candidate block header 104 (and any other data, e.g. a nonce value) to generate a sequence of hash values (also called hash digests). Alternatively, the hash function 202 may comprise multiple hashing algorithms 205, each configured to repeatedly hash at least the candidate block header 104 to generate a respective sequence of hash values. Each sequence may be output separately, or combined into a larger sequence of hash values.

The sequence(s) of hash values may be output directly to a consuming device 207. Alternatively, the sequence(s) of hash values may be output to a buffer 206 for temporarily storing the hash values. The hash values may then be extracted from the buffer 206 at a later time to be output to the consuming device. As another alternative, the hash values may be output to a processing function 301 that is configured to process (e.g. format) the hash values for use as random numbers. The processing of hash values has been described above.

Once processed, the generated random numbers may be output to the buffer 206, or to the consuming device 207. In some examples, the processing may be performed on hash values output from the buffer 206, e.g. before then being output to the consuming device 207.

In some examples, the hash values produced by the hash function 202 may be candidate proof-of-work solutions. Recall that in some blockchain protocols, a proof-of-work solution is a hash value, generated by hashing a candidate block header 104, that is below a target value. If such a hash value is generated by the hash function 202, it may be output to a block constructor 302 for constructing a new block 101n of the blockchain 102. In some examples, a generated hash value may be output to the block constructor 302 without being below the target required by the blockchain protocol, but instead below a higher target set by the block constructor 302. The block constructor 302 may be a function operated by the generating party, or by a separate mining node.

One or more of the components of the apparatus 200 may be implemented in software. That is, the apparatus 200 may comprise processing apparatus comprising one or more processors, e.g. one or more central processing units (CPUs), accelerator processors (GPUs), application specific processors and/or field programmable gate arrays (FPGAs). The apparatus may also comprise memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive. The apparatus 200 may comprises at least one user terminal, e.g. a desktop or laptop computer, a tablet, a smartphone, or a wearable device such as a smartwatch. Alternatively or additionally, the apparatus 200 may also comprise one or more other networked resources, such as cloud computing resources accessed via the user terminal (the cloud computing resources comprising resources of one or more physical server devices implemented at one or more sites).

It will be appreciated that any act described as being performed by the generating party may be performed by the apparatus 200 operated by the generating party.

Additionally or alternatively, one or more of the components of the apparatus 200 may take the form of dedicated hardware. For instance, the hashing component 202 may comprise one or more hashing devices that are specifically configured to implement a hashing algorithm. For example, the hashing component may comprise one or more application-specific integrated circuit (ASIC) mining devices, e.g. configured to implement a SHA-256 hashing algorithm. Note that in general any hashing algorithm may be used to produce the hash digests.

In some examples, the apparatus may be operated by a mining node. The mining node may operate a server comprising one or more physical server units, or even whole a data centre, for performing the functions typically associated with a mining node, e.g. those described with reference to FIG. 1. The apparatus 200 may be connected to the server, e.g. via the input interface 201.

The present invention enables a high rate of random numbers to be produced using the blockchain as a source of true randomness. In some embodiments, the apparatus of the invention harnesses the blockchain network as an entropy source, and through the use of hashing algorithms and a buffering system, produces a high-quality stream of random numbers which can be used locally and/or distributed through the internet. The random numbers are produced at a rate comparable to traditional PRNGs.

When the consuming device 207 is a local device, the apparatus can deliver enough random numbers to make complex simulations possible where previously they have not been possible due to lacking the ability to generate enough truly random numbers. In the case of WAN access, for instance, the bandwidth may be limited to the bandwidth of the internet, and thus the rate of supply of random numbers may be limited, but a separate advantage is that the apparatus may serve multiple remote consuming devices (e.g. client applications) at the same time, with each receiving upwards of 1 Gb/s of random numbers. In essence, the apparatus moves the bottleneck from the generation of true random numbers to their distribution.

It will be appreciated that the above embodiments have been described by way of example only.

More generally, according to one aspect disclosed herein there is provided a computer-implemented method of generating random numbers based on blockchain transactions, wherein the method is performed by a generating party and comprises: obtaining a candidate block header, wherein the candidate block header is based on a set of blockchain transactions; applying a hash function to at least the candidate block header one or more times, wherein each application of the hash function to at least the candidate block header generates a respective hash digest; generating one or more random numbers, wherein each random number is generated based on a respective hash digest; and outputting the one or more random numbers to one or more consuming devices.

In embodiments, said obtaining of the candidate block header may comprise obtaining the set of blockchain transactions.

In embodiments, said obtaining of the set of blockchain transactions may comprise obtaining the set of blockchain transactions from a pool of unconfirmed blockchain transactions.

In embodiments, said obtaining of the candidate block header may comprise obtaining a candidate block template, wherein the candidate block template comprises the set of blockchain transactions.

In embodiments, said applying of the hash function to at least the candidate block header may comprise applying the hash function to at least the candidate block header a plurality of times; said generating of the one or more random numbers may comprise generating a plurality of random numbers; and said outputting the one or more random numbers to the one or more consuming device may comprise outputting the plurality of random numbers to the one or more consuming devices.

In embodiments, the method may comprise storing the one or more random numbers in a buffer, wherein outputting the one or more random numbers comprises outputting the one or more random numbers comprises retrieving the one or more random numbers from the buffer.

In embodiments, the respective random number may be the respective hash digest.

In embodiments, said generating a respective random number may comprises one or more of: removing one, some or all of the zeros present in the respective hash digest; generating a fixed number as a running sum of the digits of the respective hash digest and use the fixed number as the respective random number, or a predetermined amount of least significant digits of the fixed number as the respective random number; applying a same or different hash function to the respective hash digest; converting the respective hash digest to a number between zero and one; and/or selecting a subset of the respective hash digest as the respective random number.

Applying of the same or different hash function to a hash digest removes the zero bias from the hash digest.

Converting the respective hash digest to a number between zero and one may comprise converting to a floating point number between 0 and 1. This may be required for most cases, however, some applications may just consume the raw random bitstream (i.e. the output of any of the filter methods, except the casting to a float [0-1].) For instance, the raw numbers may be output to a device that uses them to feed “/dev/random” in a Linux kernel. In general, operating systems may want to consume the raw bitstream, and end user applications and SDKs may want to consume a uniformly normalised [0-1].

In embodiments, said outputting of the one or more random numbers to the consuming device may comprise outputting the one or more random numbers to the consuming device over a respective communication channel between the generating party and the one or more consuming devices.

In embodiments, some or all of the respective communication channel may comprise an internet connection.

In embodiments, the one or more consuming devices may comprise at least one local consuming device of the generating party.

In embodiments, the one or more consuming devices may comprise at least one remote device of a second, different party.

In embodiments, the generating party may comprise a mining node of a blockchain network.

In embodiments, the mining node may be a transaction validation and/or transaction processing node.

In embodiments, the method may comprise: receiving the one or more random numbers at the consuming device; and running an application on the consuming device, wherein the application inputs the one or more random numbers to a function that generates an output based on the one or more random numbers.

According to another aspect disclosed herein, there may be provided a method comprising the actions of the generating party and, a mining node operating the mining software, and/or a consuming party operating the consuming device.

According to another aspect disclosed herein, there may be provided computer equipment comprising: memory comprising one or more memory units; and processing apparatus comprising one or more processing units, wherein the memory stores code arranged to run on the processing apparatus, the code being configured so as when on the processing apparatus to perform the method of any of the described embodiments.

According to another aspect disclosed herein, there may be provided a computer program embodied on computer-readable storage and configured so as, when run on computer equipment of claim 13, to perform the method of any of the described embodiments.

According to another aspect disclosed herein, there may be provided an apparatus configured to generate random numbers based on blockchain transactions, wherein the apparatus comprises: an input interface configured to obtain a candidate block header, wherein the candidate block header is based on a set of blockchain transactions; a hashing component configured to apply a hash function to at least the candidate block header one or more times, wherein each application of the hash function to at least the candidate block header generates a respective hash digest; and an output interface configured to output one or more random numbers to one or more consuming devices, and wherein the apparatus is configured to generate the one or more random numbers, wherein each random number is generated based on a respective hash digest.

In embodiments, the input interface may be configured to obtain the set of blockchain transactions, and wherein the apparatus is configured to generate the candidate block header.

In embodiments, the apparatus may comprise a buffer configured to store the one or more random numbers.

In embodiments, the apparatus may be configured to generate a respective random number by performing one or more of the following operations: removing one, some or all of the zeros present in the respective hash digest; generating a fixed number as a running sum of the digits of the respective hash digest and use the fixed number as the respective random number, or a predetermined amount of least significant digits of the fixed number as the respective random number; and/or applying a same or different hash function to the respective hash digest; converting the respective hash digest to a number between zero and one; and/or selecting a subset of the respective hash digest as the respective random number.

In embodiments, the apparatus may comprise at least one of the one or more consuming devices.

According to another aspect disclosed herein, there may be provided a system comprising: the apparatus of any of the described embodiments; and either one or both of i) at least one of the one or more consuming devices, and ii) a memory store comprising the set of blockchain transactions.

According to another aspect disclosed herein, there may be provided a system comprising the computer equipment of the generating party, and the computer equipment of the mining node operating the mining software, and/or the consuming device.

Other variants or use cases of the disclosed techniques may become apparent to the person skilled in the art once given the disclosure herein. The scope of the disclosure is not limited by the described embodiments but only by the accompanying claims.

1. A computer-implemented method of generating random numbers based on blockchain transactions, wherein the method is performed by a generating party and comprises:
obtaining a candidate block header, wherein the candidate block header is based on a set of blockchain transactions;
applying a hash function to at least the candidate block header one or more times, wherein each application of the hash function to at least the candidate block header generates a respective hash digest;
generating one or more random numbers, wherein each random number is generated based on a respective hash digest; and
outputting the one or more random numbers to one or more consuming devices.

2. The method of claim 1, wherein obtaining the candidate block header comprises obtaining the set of blockchain transactions.

3. The method of claim 2, wherein obtaining the set of blockchain transactions comprises obtaining the set of blockchain transactions from a pool of unconfirmed blockchain transactions.

4. The method of claim 1, wherein obtaining the candidate block header comprises obtaining a candidate block template, wherein the candidate block template comprises the set of blockchain transactions.

5. The method of claim 1, wherein:
applying the hash function to at least the candidate block header comprises applying the hash function to at least the candidate block header a plurality of times;
generating the one or more random numbers comprises generating a plurality of random numbers; and
outputting the one or more random numbers to the one or more consuming device comprises outputting the plurality of random numbers to the one or more consuming devices.

6. The method of claim 1, comprising:
storing the one or more random numbers in a buffer, wherein outputting the one or more random numbers comprises outputting the one or more random numbers comprises retrieving the one or more random numbers from the buffer.

7. The method of claim 1, wherein the respective random number is the respective hash digest.

8. The method of claim 1, wherein generating a respective random number comprises one or more of:
removing one, some or all of the zeros present in the respective hash digest;
generating a fixed number as a running sum of the digits of the respective hash digest and use the fixed number as the respective random number, or a predetermined amount of least significant digits of the fixed number as the respective random number;
applying a same or different hash function to the respective hash digest;
converting the respective hash digest to a number between zero and one; and/or
selecting a subset of the respective hash digest as the respective random number.

9. The method of claim 1, wherein outputting the one or more random numbers to the consuming device comprises outputting the one or more random numbers to the consuming device over a respective communication channel between the generating party and the one or more consuming devices.

10. The method of claim 9, wherein some or all of the respective communication channel comprises an internet connection.

11. The method of claim 1, wherein the one or more consuming devices comprises at least one local consuming device of the generating party.

12. The method of claim 1, wherein the one or more consuming devices comprises at least one remote device of a second, different party.

13. The method of claim 1, The method of any preceding claim, wherein the generating party comprises a mining node of a blockchain network.

14. (canceled)

15. A computer program embodied on computer-readable storage and configured so as, when run on computer equipment, to perform a method of generating random numbers based on blockchain transactions, wherein the method is performed by a generating party and comprises:
obtaining a candidate block header, wherein the candidate block header is based on a set of blockchain transactions;
applying a hash function to at least the candidate block header one or more times, wherein each application of the hash function to at least the candidate block header generates a respective hash digest;
generating one or more random numbers, wherein each random number is generated based on a respective hash digest; and
outputting the one or more random numbers to one or more consuming devices.

16. An apparatus configured to generate random numbers based on blockchain transactions, wherein the apparatus comprises:
an input interface configured to obtain a candidate block header, wherein the candidate block header is based on a set of blockchain transactions;
a hashing component configured to apply a hash function to at least the candidate block header one or more times, wherein each application of the hash function to at least the candidate block header generates a respective hash digest; and
an output interface configured to output one or more random numbers to one or more consuming devices, and
wherein the apparatus is configured to generate the one or more random numbers, wherein each random number is generated based on a respective hash digest.

17. The apparatus of claim 16, wherein the input interface configured to obtain the set of blockchain transactions, and wherein the apparatus is configured to generate the candidate block header.

18. The apparatus of claim 16, wherein the apparatus comprises a buffer configured to store the one or more random numbers.

19. The apparatus of claim 16, wherein the apparatus is configured to generate a respective random number by performing one or more of the following operations:
removing one, some or all of the zeros present in the respective hash digest;
generating a fixed number as a running sum of the digits of the respective hash digest and use the fixed number as the respective random number, or a predetermined amount of least significant digits of the fixed number as the respective random number;
applying a same or different hash function to the respective hash digest;
converting the respective hash digest to a number between zero and one; and/or
selecting a subset of the respective hash digest as the respective random number.

20. The apparatus of claim 16, wherein the apparatus comprises at least one of the one or more consuming devices.

21. (canceled)
